(19) United States
(12) Patent Application Publication
(10) Pub. No.: US 2024/0362956 A1
(43) Pub. Date: Oct. 31, 2024

(54) IMMUTABLE VEHICLE HEALTH RECORD SYSTEM AND METHOD

(71) Applicant: CarTechIQ, Inc., Wylie, TX (US)

(72) Inventors: James R. Smith, Wylie, TX (US); Yuri Radzik, Fair Oak, CA (US)

(21) Appl. No.: 18/642,567

(22) Filed: Apr. 22, 2024

Related U.S. Application Data
(60) Provisional application No. 63/462,728, filed on Apr. 28, 2023.
(60) Provisional application No. 63/542,808, filed on Oct. 6, 2023.

(51) Int. Cl. G07C 5/00

(52) U.S. Cl. CPC G07C 5/008; G07C 5/006

(57) ABSTRACT

A vehicle health record system and method are described herein that stores comprehensive vehicle data selected from the group consisting of vehicle identification number, vehicle build data, department of motor vehicle data, vehicle parts data, vehicle maintenance data, vehicle repair data, collision data, insurance claim data, vehicle diagnostic data, recall data, vehicle pricing data, and connected car data in a blockchain to provide accurate and reliable representation of a vehicle's history that may be used by a variety of end users for transactions related to the vehicles, including uses related to buy-sell, maintenance, repairs, and insurance transactions. The system further uses artificial intelligence and machine learning technologies to gain insight and provide value-added derivative products and services to all entities engaged in transactions related to vehicles. The system and method described herein can be applied to all types of valuable vehicles and machinery.

### RELATED APPLICATIONS

The present application claims the benefit of U.S. Provisional Patent Application Nos. 63/462,728 filed on Apr. 28, 2023 and 63/542,808 filed on Oct. 6, 2023, both of which is incorporated herein by reference in entirety.

### FIELD

The present disclosure relates generally to an AI and blockchain-based vehicle health record (VHR) system, and more particularly to a decentralized, secure, and transparent platform for storing, managing, and accessing vehicle repair information, build information, OEM and aftermarket diagnostic scans, recall information, diagnostics information, connected car information, DMV history, accident information, insurance claim information, and others.

### BACKGROUND

As vehicles become more complex and integrated with various technologies, it is increasingly important for car owners, repair shops, and related stakeholders to access accurate and up-to-date vehicle health information. Traditional record-keeping methods are prone to errors, fraud, and mismanagement and often lack transparency and accessibility. Thus, there is a need for a secure, reliable, and easily accessible vehicle health record system that can address these issues and provide a trusted platform for managing and sharing vehicle information.

Repair shops and vehicle owners do not always have a complete picture of the history of a vehicle, resulting in misdiagnoses, undervaluation, a longer key to key cycles, and incorrect part purchases. OEM diagnostic scan tools and dealership management systems are used in the first few years to aftermarket diagnostic scan tools, shop management systems, and collision estimating systems in the middle years to recycling management systems in the last few years. Each of these types of systems provides data in a different format and uses different nomenclature which causes confusion to the vehicle owner, the shops, and other stake holders.

### BRIEF DESCRIPTION OF THE DRAWINGS

FIG. 1 is a simplified block diagram of a preferred embodiment of an AI and blockchain-based vehicle health record (VHR) system according to the teachings of the present disclosure;

FIG. 2 is a block diagram of the layered architecture of the AI and blockchain-based vehicle health record system according to the teachings of the present disclosure;

FIG. 3 is a top-level data flow diagram of a preferred embodiment of the AI and blockchain-based vehicle health record system according to the teachings of the present disclosure;

FIG. 4 is a flowchart of a preferred embodiment of the AI and blockchain-based vehicle health record system according to the teachings of the present disclosure; and

FIG. 5 is a simplified block diagram of an operating environment of the AI and blockchain-based vehicle health record system according to the teachings of the present disclosure.

### DETAILED DESCRIPTION

The present disclosure describes an AI and blockchain-based vehicle health record (VHR) system and method 100 that are accessible to members of the public that provide a verified and validated value for automotive vehicles. The VHR system and method 100 ensure data immutability and security using blockchain technology and is particularly beneficial for any entity dealing in transactions involving automotive vehicles to access detailed and accurate information about a vehicle.

The blockchain is a distributed ledger with growing lists of records (blocks) that are securely linked together via cryptographic hashes. Each block contains a cryptographic hash of the previous block, a timestamp, and transaction data. The timestamp proves that the transaction data existed when the block was created. Since each block contains information about the previous block, they effectively form a chain, with each additional block linking to the ones before it. Consequently, blockchain transactions are irreversible in that, once they are recorded, the data in any given block cannot be altered retroactively without altering all subsequent blocks. The blockchain is managed by a peer-to-peer (P2P) computer network for use as a public distributed ledger, where nodes collectively adhere to a consensus algorithm protocol to add and validate new transaction blocks.

The VHR system and method 100 are the foundation for derivative products and services such as diagnostic code fixes, common module nomenclature, automotive window stickers, and validated build sheets. The VHR system 100 also includes AI/machine learning (ML) modeling technology to generate additional derivative products and services, such as PredictaFix that provide predictive repair recommendations based on diagnostic trouble codes, connected car data, mechanical and collision repair estimates, registration data, and other touch point data related to the vehicle lifecycle. The vehicle data and derivative products/services are associated with a specific YMME (year/make/model/engine) combination, normalized AutoLingo (nomenclature) of specific vehicle modules, parts, structures and other data points. It also includes vehicle history specifically associated with the VIN (Vehicle Identification Number) and associated to YMME.

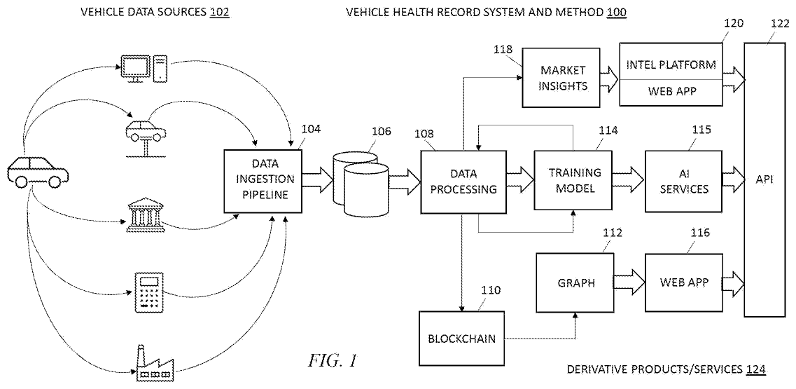

FIG. 1 is a simplified block diagram of a preferred embodiment of an AI and blockchain-based vehicle health record or VHR system 100 according to the teachings of the present disclosure. The VHR system 100 ingests vehicle data from a number of data sources 102 that provide a variety of data related to the vehicles, including vehicle build information, ownership information, recall information, repair information, diagnostics information, repair estimates, connected-car information, DMV (Department of Motor Vehicle) history, accident information, insurance information, and other vehicle data. The system 100 is seamlessly integrated or interfaced with shop management systems, OEM (Original Equipment Manufacturer) databases, and other vehicle data sources, so that vehicle data may be automatically accessed or pulled on a periodic and/or real-time basis. The VHR system 100 automatically ingests vehicle data from these various sources 102 via, for example, one or more data ingestion pipelines 104 and stores the data in one or more raw vehicle data databases (i.e., data lakes) 106. The use of a data lake allows for the storage of unstructured data without requiring pre-processing or transformation of the data into specific formats or structures. The VHR system 100 then performs data processing on the vehicle data (108), including removing personally identifiable information (PII) from the vehicle data in the database 106 for privacy concerns and normalizing the data.

In particular, the VHR system and method 100 is preferably integrated with these vehicle data sources 102 using application programming interfaces (APIs) that automatically ingest or collect data from the vehicle data sources 102. APIs typically use HTTP methods such as GET to retrieve data from a data source. The vehicle data sources may include automobile estimatic, shop management, parts provider, diagnostic systems, and other sources to create a comprehensive vehicle health record for each vehicle. In the automotive industry, estimatics refers to the process of estimating the cost of repairing a damaged vehicle. It involves assessing the extent of the damage, identifying the required repairs, and calculating the cost of labor, parts, and materials needed to restore the vehicle to its pre-accident condition. Estimators typically use specialized software to help them accurately estimate the cost of repairs. The estimator software takes into account the labor rates and parts prices in the specific geographic location where the repairs will be made, as well as the make, model, and year of the vehicle. Estimators may work for insurance companies, auto body shops, or independent appraisal firms. Their estimates are used to determine the amount of money that will be paid out by insurance companies to cover the cost of repairs. The VHR system 100 is configured to automatically interface with and collect historical and live data from shop management, estimators, diagnostics, and other functionality software systems.

The vehicle data are collected in a data lake 106, then normalized, and given weighted values to different types of data and data records to enhance the accuracy and reliability of the data records. Derivatives of the weighted data records are generated. Each data recode type is given a weight or a value for all the derivatives. This enables a determination of whether the vehicle information is complete and provides an accuracy estimate of the derivatives.

For example, when the system 100 receives a diagnostics report from an automotive shop, it is given a weight for 100 for vehicle valuation, 70 for fix verification, 80 for nomenclature normalization, and 10 for build configuration. However, if the diagnostics report indicates that a previously undetermined module (ECM or engine control unit) exists, then the weight for the build configuration is instead set to 150 to show the added value. This process enables the machine learning (ML) algorithm to learn what type of data matters and by how much. This helps the Large Language Model (LLM) 114 to know how to respond or act when the same diagnostics code shows up for different vehicles. For example, the same diagnostics code might mean one thing for a Ford vehicle but something different for a Chevrolet. The VHR system 100 performs a normalization and weighting of the historical information: this includes, but is not limited to, part names, module names, repairs, registration locations, purchase events, and accident events. The weighting of the value of the different data records may focus on the reliability of the data which is dependent on where the data record came from (e.g., a First Notice of Loss event, Motor Vehicle Department, an Aftermarket tool provider, or an Original Equipment Manufacturer).

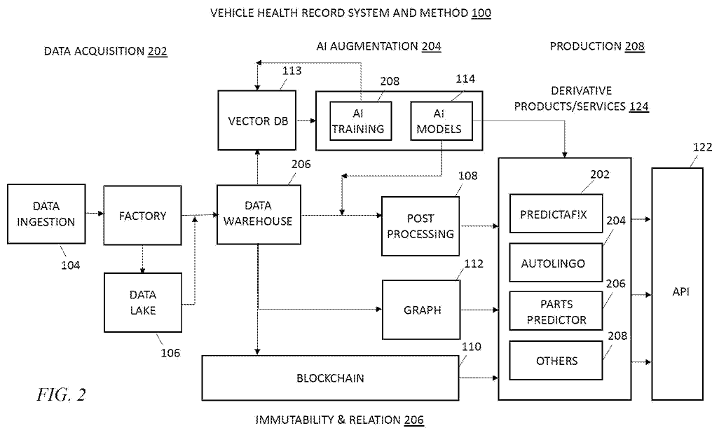

FIG. 2 provides additional insights into the AI/ML aspects of the VHR system 100. The VHR system and method 100 include continuous analytics methods and processes that take the normalized and weighted vehicle data from the data warehouse 206 to train machine learning (ML) models 208 and uncover new insights. The trained AI/ML models 114 are utilized to augment the vehicle data with newly generated insights. This process is used to generate various AI/ML-based derivative products and services 124, such as PredictaFix 202, Autolingo 204, Parts Predictor 206, and others 208.

Unlike other vehicle record systems that are dedicated to specific applications such as for vehicle buy-sell transactions, the VHR system and method 100 described herein can be used for a number of applications. For example, the VHR system 100 can offer stronger insights into the vehicle history, its current health, and offer predictions on needed repairs and recommended maintenance for each vehicle. Using a predictive insight technology, the system 100 can generate a forecast of potential repairs on a particular vehicle given its use (with Telematics, which is vehicle onboard communication services and applications that communicate with one another via GPS receivers and other telematics devices), location conditions (with Connected Car data from cars that can communicate bidirectionally with other systems outside of the car that allows the car to share internet access, and hence data, with other devices both inside and outside the vehicle), weather patterns, and other data that will allow for additional insights to its current and future condition (PredictaFix). The VHR system 100 is also capable of identifying missing elements, such as maintenance or replacement of vehicle parts and components that have not been performed, and generate a market or trade-in value for each vehicle based on a number of different vehicle data points. For example, if oil changes in a vehicle's maintenance history is always significantly late or have gaps, the value of the vehicle may be adversely impacted. Therefore, the market value of any vehicle can be scientifically and comprehensively based on the actual use, maintenance, repair, and performance history of the vehicle.

The VHR system 100 includes capabilities to generate derivative products and services 124 including predictive repairs based on diagnostic trouble codes and a specific YMME (year/make/model/engine) combination (PredictaFix 202), normalized AutoLingo (nomenclature) of specific vehicle modules 204, and vehicle history specifically associated with the VIN (Vehicle Identification Number) and associated to YMME.

The VHR system and method 100 uniquely focus on collecting data records from different verticals of the Automotive Marketplace including, but not limited to, Diagnostics, Mechanical Repair, Collision Repair & First Notice of Loss, Connect Car Telematics, Registration data sources, and more. As shown in FIG. 1, using a blockchain 110 to store the vehicle data, the data is immutable, secure, and traceable, ensuring the integrity of the data. The VHR system 100 takes the additional steps of utilizing a graph database 112 to build connection points between the different data records, tables, models, and vector databases 113 to empower the machine learning models 114 and web applications 116 to provide AI-based Vehicle Health services 115. The graph databases 112 allow for the efficient representation and querying of complex relationships between data records, making them powerful tools for applications that require intricate data connections and pattern recognition. The VHR system and method 100 may further use market insights or generate market insights 118 to provide additional derivative products and services via intelligent platforms and web applications 120. These are the AI-based derivative products and services 124 that may also be accessible by third party entities via APIs 122.

FIG. 2 is a block diagram of the layered architecture of the AI and blockchain-based vehicle health record system 100 according to the teachings of the present disclosure. FIG. 2 shows a comprehensive VHR system for managing and utilizing partner data that enables fast retrieval, immutability, relation-finding, and scalable exposure to the public. The system architecture comprises four main layers: Data Acquisition 202, AI Augmentation 204, Immutability and Relation 206, and Production 208. These are described in more detail below.

The Data Acquisition layer 202 includes systems for automatically obtaining and ingesting partner data from various data sources and channels, which are stored in a data lake 106, normalized, and stored in a data warehouse 206.

The AI Augmentation layer 204 includes vector databases 113 that store vector embeddings for fast data retrieval, enabling new AI models 114. The vector database 113 is a specialized type of database designed to store and manage high-dimensional data, such as embeddings, vectors, or data points from machine learning models. The vector databases 113 enable fast and efficient retrieval of similar data points for AI and ML applications. The AI models 114 are used to augment the data for packaging and in the Production layer 208 for generating responses to prompts from the production systems.

The Immutability and Relation layer 208 uses blockchain technology 110 for immutability and a graph database 112 for finding relations between nodes. The data is passed into the blockchain 110 from the data warehouse 206 in a structured format, ensuring it is accurately associated to the correct vehicle. The graph databases 112 allow for the efficient representation and querying of complex relationships between data records, making them powerful tools for applications that require intricate data connections and pattern recognition. The graph database 112 manages massive connections between nodes, reducing the complexity of the data landscape.

The Production layer 208 exposes the packaged data and generative AI to the public/partners/customers through an API, a message-driven microservice architecture behind a scalable API gateway 122. The VHR data is primarily accessible through the production layer 208, along with derivative products and services 124. The derivative products and services 124 are the results of data processing and data augmentation using AI and ML technologies to provide valuable insights and predictions related to the vehicles.

The system and method 100 further comprise continuous analytics methods and processes that take the data from the data warehouse 206 to train machine learning models 114/208 and uncover new insights. The trained models 114 are utilized to augment the vehicle data with newly generated insights based on newly acquired data. This process generates various derivatives, such as PredictaFix 202, Autolingo 204, Parts Predictor 206, and others 208.

Finally, the VHS system and method 100 package the augmented data into elements usable by the API and, in some cases, deliver them directly to the customer. The invention, therefore, provides a scalable and efficient method for processing and augmenting data to provide valuable insights and predictions.

In summary, the AI and blockchain-based vehicle health record (VHR) system and method 100 include the following features:

Immutability and Security 206: By utilizing blockchain technology, the VHR system 100 ensures that once vehicle information is added and entered into the blockchain 110, it cannot be altered or tampered with, thus providing a secure and reliable source of information related to the vehicles.

Public Accessibility: The VHR system 100 allows public access to vehicle health information and more, enabling car owners, repair shops, and other stakeholders to obtain updated, relevant, and accurate vehicle data. The public and service providers may be given access to the information stored in the blockchain 110 for any suitable need or value-added application.

Data Privacy: The VHR system 100 removes personally identifiable information (PII) to address privacy concerns while maintaining the integrity of vehicle data in the blockchain 110.

Comprehensive Data Storage: The VHR system 100 stores repair information, build information, recall information, diagnostics information, connected car information, DMV history, accident information, insurance claim information, and other data related to each vehicle, thus providing a comprehensive view of a vehicle's history and health.

Integration with External Systems: The VHR system 100 is designed to integrate with shop management systems, OEM databases, and other vehicle data sources 102, thus facilitating seamless data exchange and improving overall efficiency. Examples of data integration may include a REST API (application programming interface) gateway (A REST API is an API that conforms to the design principles of the REST, or representational state transfer architectural style) and portal (data transmitted via a webhook), SFTP (Secure File Transfer Protocol) portals when files (estimates, repair orders, invoices) can be dropped for processing, and WebSocket connections with IoT (Internet of Things) devices push Realtime data into the pipeline.

Foundation for Derivative Products and Services 124: The VHR system 100 serves as a base for creating derivative works such as diagnostic code fixes and automotive window stickers that provide comprehensive information about used vehicles, thus promoting innovation and value-added services within the automotive industry.

Decentralized Management: The VHR system 100 is managed through a decentralized network, removing the need for a central authority and ensuring transparency, reliability, and data security.

Unlimited Access and Input: The VHR system 100 imposes no limitations on the access or input of data, allowing any stakeholder to contribute to and benefit from the platform.

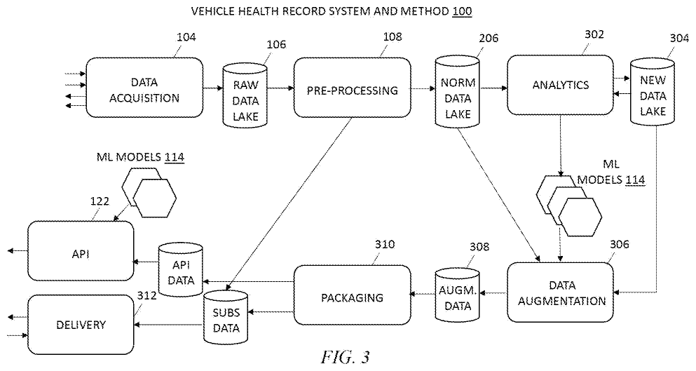

FIG. 3 is a top-level data flow diagram of a preferred embodiment of the AI and blockchain-based vehicle health record system 100 according to the teachings of the present disclosure. FIG. 3 shows a system and method for processing and augmenting data to provide valuable insights and predictions based on AI/ML. The system and method 100 include a data acquisition process 104 that automatically receives vehicle data through various ingestion methods, such as webhooks or SFTP (Secure File Transfer Protocol). The acquired data is pushed into a Data Lake (Raw Data Lake) 106 to handle the unstructured and un-normalized nature of the acquired data. The VHR system 100 also includes a pre-processing stage 108 that transforms the vehicle data from amorphous to a usable structured and normalized format, which is then stored in a data warehouse (Norm Data Lake) 206. The VHR system 100 uses continuous analytics methods and processes 302 that take the normalized and weighted vehicle data from the norm data lake 206 to train ML models 114 and uncover new insights, which are stored in new data lake 304. The trained models 114 are utilized to augment the data 306 with newly generated insights based on newly acquired data. The VHR system 100 then packages (310) the augmented data 308 into elements usable and/or accessible via the API 122 and, in some cases, delivered directly to the customer and end users 312. The VHR system and method 100, therefore, provides a scalable and efficient method for processing and augmenting data to provide valuable AI-based insights and predictions.

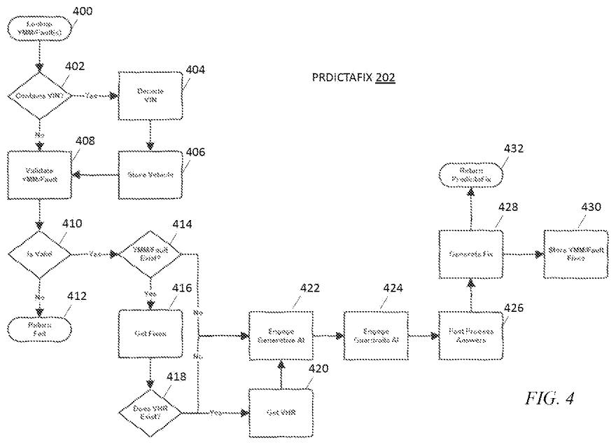

FIG. 4 is a system flow diagram of a preferred embodiment of a specific function 400 of the blockchain-based vehicle health record system 100 according to the teachings of the present disclosure. The diagram describes a novel system for efficiently generating fixes for fault codes while ensuring that the output is accurate, understandable, and compliant with company standards. This function, called Predictafix 202, generates fixes for one or many fault codes using generative AI. The procedure is initiated by a “lookup” request 400, which is evaluated to ensure the YMME data meets the minimum requirements for engaging the generative AI function. The Predictafix 202 then proceeds to decode the Vehicle Identification Number (VIN) if it exists (402) and decode (404), store (406), and verify it against known VIN formats to ensure that the request is for an actual vehicle Year, Make, and Model (408), and that the fault is possible for the same. Upon successful validation (determined in 410 and returned fail in 412), the algorithm 400 engages the AI or prompts the user to input the necessary data (416). If the Vehicle History Report (VHR) exists (418), the prompt is augmented with the VHR data relevant to the AI request (422 and 424). The generated result is then passed to a Grammar AI (426) to generate an output (428), ensuring the output is understood and presented in a Theme and Voice appropriate for the customer (426). For example, the result is returned in Spanish if the request was made in Spanish. The output is then preprocessed to ensure compliance with company standards and finally passed on to the customer (432) and stored for later retrieval (430).

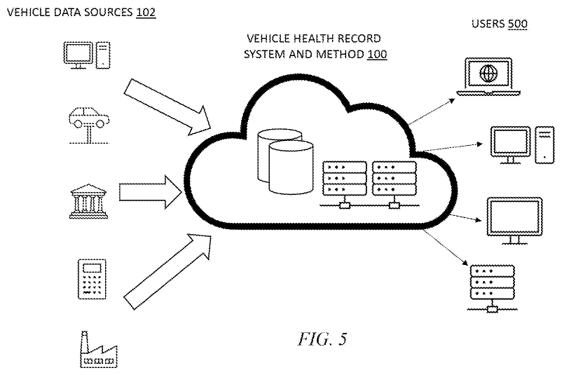

FIG. 5 is a simplified block diagram of the operating environment of the VHR system and method 100. The VHR system 100 may employ cloud-based servers and data storage devices that provide users 500 with the ability to access value-added data, insights, and derivative products and services easily and efficiently. The VHR system 100 also takes advantage of the benefits of using cloud-based servers and data storage devices such as redundancy, scalability, flexibility, and reliability.

Although the description herein has been focused on automotive vehicles, the system and method 100 described herein can be applied to any type of valuable vehicle and machinery that may have a maintenance, repair, and ownership history, such as earthmoving vehicles (excavators, loaders, bulldozers, graders, compactors, dump trucks, etc.), watercrafts (maritime ships, barges, tankers, ferries, container ships, motorboats, catamarans, sailboats, yachts, jet skis, etc.), and others.

The features of the present invention which are believed to be novel are set forth below with particularity in the appended claims. However, modifications, variations, and changes to the exemplary embodiments of the AI and block-chain based vehicle health record system and method described above will be apparent to those skilled in the art, and the described herein thus encompasses such modifications, variations, and changes and are not limited to the specific embodiments described herein.

What is claimed is:

1. A vehicle health record system comprising:
a plurality of application programming interfaces configured to interface with a plurality of data sources to automatically access and ingest vehicle data associated with a plurality of automotive vehicles, the data being selected from the group consisting of vehicle identification number, vehicle build data, department of motor vehicle data, vehicle parts data, vehicle maintenance data, vehicle repair data, collision data, insurance claim data, vehicle diagnostic data, recall data, vehicle pricing data, and connected car data;
a raw data lake configured to receive and store the ingested vehicle data;
a server coupled to the plurality of application programming interfaces and the raw data lake, the server configured to receive the ingested vehicle data and perform processes selected from the group consisting of: removing personal identification information from the ingested data, normalizing, and formatting the data, and to store the processed vehicle data in a normalized data lake;
the server being configured to store the processed vehicle data in a plurality of data records of a blockchain, the processed vehicle data being automatically propagated to all copies of the blockchain; and
the server being configured to enable authorized access to the processed vehicle data in the blockchain.

2. The vehicle health record system of claim 1, wherein the server is configured to enable creation of AI-based derivative products and services based on the processed vehicle data.

3. The vehicle health record system of claim 1, further comprising a graph database used to identify and build relationship connections between data in the normalized data lake.

4. The vehicle health record system of claim 1, further comprising a graph database used to enable fast and efficient retrieval of similar data points from the normalized data lake.

5. The vehicle health record system of claim 1, further comprising machine learning models used to analyze the data in the normalized data lake to gain insight and generate value-added information and derivative products and services.

6. The vehicle health record system of claim 5, wherein the machine learning models comprises a machine learning model logic configured to provide predictive repair and maintenance recommendations.

7. A vehicle health record system comprising:
an application programming interface logic module configured to interface with a plurality of data sources to automatically access and ingest vehicle data associated with a plurality of automotive vehicles, the data being selected from the group consisting of vehicle identification number, vehicle build data, department of motor vehicle data, vehicle parts data, vehicle maintenance data, vehicle repair data, collision data, insurance claim data, vehicle diagnostic data, recall data, vehicle pricing data, and connected car data;
a raw data lake configured to receive and store the ingested vehicle data;
a server coupled to the application programming interface logic module and the raw data lake, the server having logic configured to:
access the vehicle data in the raw data lake;
perform processes selected from the group consisting of: removing personal identification information from the ingested data, normalizing, formatting the data, storing the processed vehicle data in a normalized data lake;
the server further having logic configured to store the processed vehicle data in a plurality of data records of a blockchain, the processed vehicle data being automatically propagated to all copies of the blockchain, enable authorized access to the processed vehicle data in the blockchain by authorized users.

8. The vehicle health record system of claim 7, wherein the server is configured to enable creation of AI-based derivative products and services based on the processed vehicle data.

9. The vehicle health record system of claim 7, further comprising a graph database used to identify and build relationship connections between data in the normalized data lake.

10. The vehicle health record system of claim 7, further comprising a vector database used to enable fast and efficient retrieval of similar data points from the normalized data lake.

11. The vehicle health record system of claim 7, further comprising machine learning models used to analyze the data in the normalized data lake to gain insight and generate value-added information and derivative products and services.

12. The vehicle health record system of claim 7, wherein the machine learning models comprises a machine learning model logic configured to provide predictive repair and maintenance recommendations.

13. The vehicle health record system of claim 7, further comprising a second application programming interface logic module coupled to the server to enable efficient and easy authorized access to the blockchain data records.

14. The vehicle health record system of claim 8, further comprising a second application programming interface logic module coupled to the server to enable efficient and easy authorized access to the AI-based derivative products and services.

15. A vehicle health record method comprising:
automatically interfacing with a plurality of data sources to automatically access and ingest vehicle data associated with a plurality of automotive vehicles, the data being selected from the group consisting of vehicle identification number, vehicle build data, department of motor vehicle data, vehicle parts data, vehicle maintenance data, vehicle repair data, collision data, insurance claim data, vehicle diagnostic data, recall data, vehicle pricing data, and connected car data;
storing the ingested vehicle data in a raw data lake;
removing personal identification information from the ingested vehicle data, normalizing the data, and generating pre-processed vehicle data;
storing the pre-processed vehicle data in a normalized data lake;
storing a version of the pre-processed vehicle data in a plurality of data records of a blockchain, the vehicle data being automatically propagated to all copies of the blockchain; and
enabling authorized access to the vehicle data in the blockchain.

16. The vehicle health record method of claim 15, further comprising enabling creation of derivative products and services based at least in part on the pre-processed vehicle data stored in the normalized data lake.

17. The vehicle health record method of claim 15, further comprising:
using graph database techniques to identify and build relationship connections between data in the normalized data lake; and
using vector database techniques to enable fast and efficient retrieval of similar data points from the normalized data lake.

18. The vehicle health record method of claim 15, further comprising building and training machine learning models to analyze the data in the normalized data lake to gain insight and generate value-added information and derivative products and services.

19. The vehicle health record method of claim 15, further comprising building and training machine learning models to analyze the data in the normalized data lake to provide predictive repair and maintenance recommendations.

20. The vehicle health record method of claim 18, further comprising providing authorized access via a second application programming interface logic module coupled to the server for efficient and easy authorized access to the blockchain data records and the AI-based derivative products and services.
